(19) United States
(12) Patent Application Publication
(10) Pub. No.: US 2012/0286956 A1
(43) Pub. Date: Nov. 15, 2012

(54) BIRD REPELLING DEVICE

(76) Inventor: Jung Mi Lee, Yongin-si (KR)

(21) Appl. No.: 13/519,693

(22) PCT Filed: Dec. 30, 2010
(86) PCT No.: PCT/KR2010/009600

§ 371 Date: Jun. 28, 2012

(30) Foreign Application Priority Data
Dec. 31, 2009 (KR) 10-2009-0135068

(51) Int. Cl. A01M 29/26

(52) U.S. Cl. 340/573.2

(57) ABSTRACT

A bird repelling device includes a solar cell panel which collects solar heat and converts the collected solar heat into electrical energy; a charging unit which stores the electrical energy received from the solar cell panel; a controller which controls the electrical energy stored in the charging unit; a bird sensor which receives power from the charging unit and detects the approach of birds; a sound generating unit and a sound wave generating unit which are operated by a signal transmitted from the bird sensor; a moving unit which is moved by a drive motor that is operated by a signal transmitted from the bird sensor; and a hollow body which is coupled to the solar cell panel and houses the charging device, the controller and the drive motor therein.

### TECHNICAL FIELD

The present invention relates, in general, to bird repelling devices and, more particularly, to a bird repelling device which prevents birds from approaching a telephone pole, an orchard or farmland (a planted field) and from building a nest on a telephone pole.

### BACKGROUND ART

Generally, to supply high-voltage current from power plants to consumers such as factories, high-tension wires are connected therebetween for very long geographical distances. However, because such high-tension wires are very heavy, the following process is required to install high-tension wires without making them sag, that is, telephone poles are installed at regular intervals, support frames such as cross arms are provided on an upper end of each telephone pole, insulators that are the medium for the connection of high-tension wires, a mounting frame and so on are provided on the cross arms, and then the high-tension wires are connected to them and supported by the cross arms.

Typically, a predetermined space is defined between the cross arms on which the insulators, the mounting frames, etc. are installed. Birds such as magpies or small animals such as squirrels sometimes build houses (nests) in this space.

However, when birds or other animals build houses, they frequently use thin long pieces of wire rather than just twigs. In this case, there is the possibility that the high-tension wires will short, causing electrical incidents such as a power failure. These electrical incidents incur great social and economic loss.

To overcome the above problems, a variety of types of devices such as pinwheels or rotary plates have been provided on the tops of telephone poles to prevent birds such as magpies or small animals from approaching the telephone poles so that they cannot build houses there.

However, the conventional prevention devices need external force, e.g. the wind, and elements such as rotary bearings. If there is no wind or the elements malfunction, for example, due to rusting with the passage of time, the devices cannot perform their intended function. Therefore, over the long term, the conventional devices may become useless.

Birds also damage orchards or farmlands (planted fields), deteriorating the merchantable quality of fruits, and reducing the size of the harvest. In other words, birds have caused large financial damage to farmers.

### DISCLOSURE

### Technical Problem

Accordingly, the present invention has been made keeping in mind the above problems occurring in the prior art, and an object of the present invention is to provide a bird repelling device in which when a bird sensor detects the motion of birds or the like around a telephone pole, a sound generating unit, a sound wave generating unit and a moving unit are operated to impede the birds from approaching the telephone pole and from building a nest, thus preventing electrical components or wires installed on the telephone pole from being damaged or contaminated by the birds, and preventing a nest made of metallic substances from causing a power failure incident.

Another object of the present invention is to provide a bird repelling device in which the bird sensor detects the approach of birds, and only when birds approach the device are the sound generating unit, the sound wave generating unit and the moving unit operated to repel the birds, thus reducing power consumption, and which uses a solar cell to provide power, thus conserving energy.

A further object of the present invention is to provide a bird repelling device which may be installed on a place such as an orchard or farmland (a planted field), thus preventing birds or other wild animals from approaching the orchard or farmland and from damaging fruit trees or crops.

### Technical Solution

In order to accomplish the above objects, the present invention provides a bird repelling device, including an electricity supply unit, a bird sensor receiving power from the electricity supply unit, the bird sensor detecting approach of birds, a sound generating unit and a sound wave generating unit operated by a signal transmitted from the bird sensor, and a moving unit moved by a drive motor that is operated by a signal transmitted from the bird sensor. The moving unit includes a rotary rod connected to a drive shaft of the drive motor, the rotary rod being rotated by the drive shaft, and a bird repelling unit mounted to the rotary rod so that the bird rod rotates to repel the birds.

The electricity supply unit may include a solar cell panel collecting solar heat and converting the collected heat energy into an electrical energy, a charging device accumulating the electrical energy transmitted from the solar cell panel, and a controller controlling the electrical energy accumulated in the charging device.

The bird repelling device may further include a hollow body coupled to a lower end of the solar cell panel, the hollow body housing the charging device, the controller and the drive motor therein.

The bird repelling unit may include a plurality of support rods installed on the rotary rod at positions spaced apart from each other at predetermined intervals. The support rods may be perpendicular to the rotary rod. Preferably, the support rods may be disposed on opposite sides of the rotary rod.

The bird repelling unit may further include a tassel provided on an end of each of the support rods. The tassel may have different colors and flutter in a wind.

The bird repelling unit may further include an LED provided on an end of each of the support rods. The LED may receive power from the electricity supply unit and emit lights of different colors.

The bird repelling device may further include a smoke screen generating unit operated by a signal transmitted from the bird sensor. The smoke screen generating unit may use a chemical and discharge dense smoke and smell, thus producing an effect of a smoke bomb. The smoke screen generating unit may include an LED emitting light, thus simulating conditions of fire.

The bird repelling device may further include a shooting unit operated by a signal transmitted from the bird sensor. The shooting unit may shoot a plate to repel the birds.

The shooting unit may be configured such that the plate flies over a large area using a principle of a boomerang and then falls onto a ground around a position at which the plate has been launched.

The bird repelling device may further include an air supply type repelling unit operated by a signal transmitted from the bird sensor. The air supply type repelling unit may include a long tube configured such that when air is injected into the long tube that has been drooped or rolled, the tube is momentarily extended, thus frightening the birds and repelling the birds.

### Advantageous Effects

In a bird repelling device according to the present invention, when a bird sensor detects motion of birds or the like around a telephone pole, a sound generating unit and a sound wave generating unit generate sounds and sound waves, and a drive motor is operated to move a moving unit so that a pinwheel, tassel or an LED unit can become more active. Thereby, the bird repelling device prevents birds from approaching the telephone pole and from building a nest, thus preventing electrical components or wires installed on the telephone pole from being damaged or contaminated by the birds, and preventing a nest made of metallic substances from causing a power failure incident.

Furthermore, the bird sensor detects the approach of birds, and only when birds approach the device are the sound generating unit, the sound wave generating unit and the moving unit operated, thus reducing power consumption. Moreover, the bird repelling device uses a solar cell to provide power so that a separate power supply component is not required. Hence, the installation of the bird repelling device can be facilitated. As such, the bird repelling device of the present invention can efficiently and environment-friendly repel birds or the like without injuring them.

In addition, the bird repelling device of the present invention may be installed on a place such as an orchard or farmland (a planted field), thus preventing birds or other wild animals from approaching the orchard or farmland and from damaging fruit trees or crops.

### DESCRIPTION OF DRAWINGS

FIG. 1 is a schematic view showing the installation of a bird repelling device, according to a first embodiment of the present invention;

FIG. 2 is a perspective view of the bird repelling device of FIG. 1;

FIG. 3 is a longitudinal sectional view of the bird repelling device of FIG. 2;

FIG. 4 is an enlarged view of a critical portion of the bird repelling device of FIG. 2;

FIG. 5 is a schematic view showing the installation of a bird repelling device, according to a second embodiment of the present invention; and

FIG. 6 is a schematic view showing the installation of a bird repelling device, according to a third embodiment of the present invention.

### BEST MODE

Hereinafter, preferred embodiments of the present invention will be described in detail with reference to the attached drawings so that those skilled to this art can easily embody the present invention.

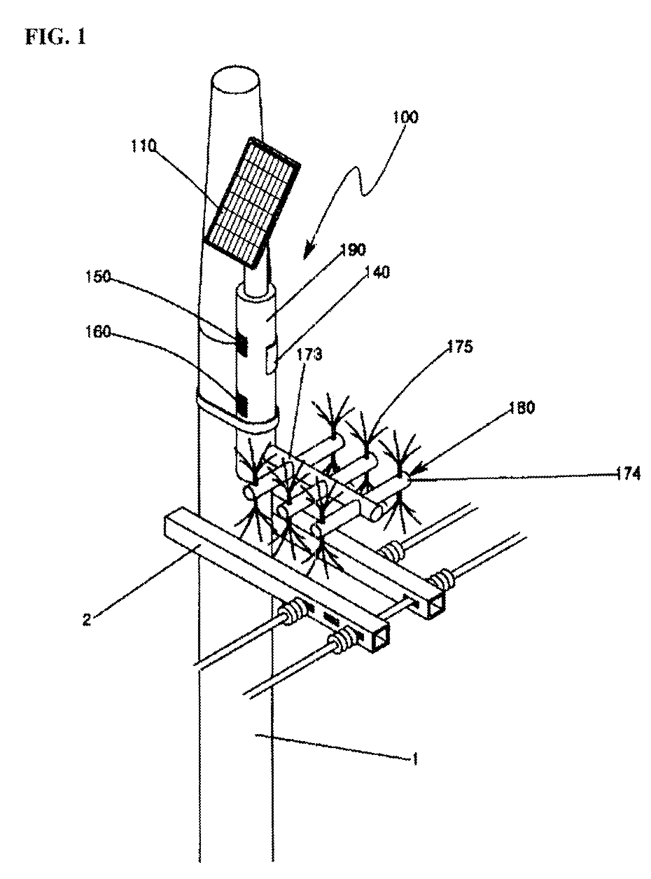

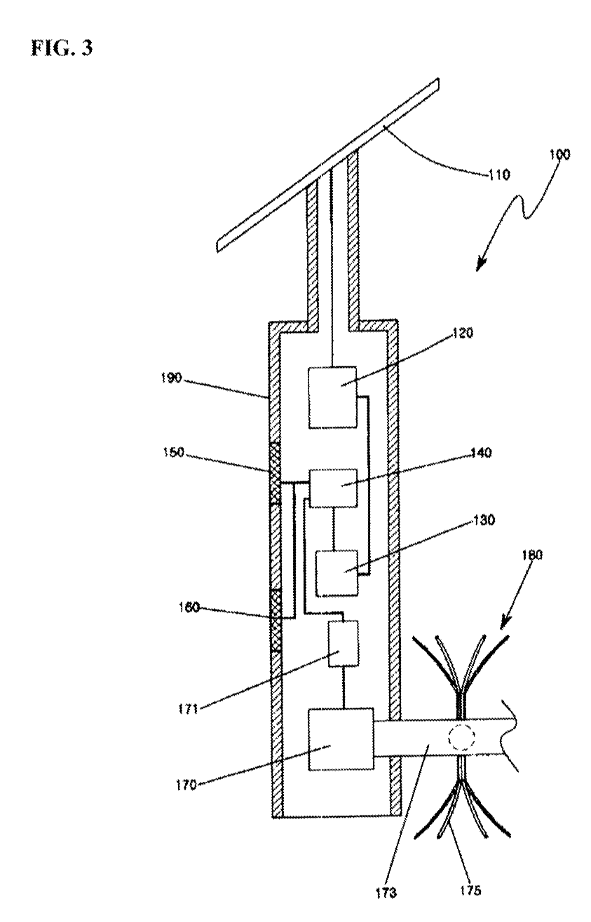

As shown in FIGS. 1 through 4, a bird repelling device 100 according to a first embodiment of the present invention is installed above a cross arm 2 of a telephone pole 1 which supports high-tension wires. The bird repelling device 100 includes: a solar cell panel 110 which collects solar heat and converts collected heat energy into electrical energy; a charging device 120 which accumulates electrical energy transmitted from the solar cell panel 110; a controller 130 which controls electrical energy accumulated in the charging device 120; a bird sensor 140 which is operated by power supplied from the charging device 120 and detects the approach of a bird around the telephone pole; a sound generating unit 150 and a sound wave generating unit 160 which are operated by signals transmitted from the bird sensor 140; a moving unit 180 which is operated by a drive motor 170 by a signal transmitted from the bird sensor 140; a hollow body 190 which is connected to a lower end of the solar cell panel 110 and houses the charging device 120, the controller 130 and the drive motor 170 therein.

The charging device 120, the controller 130 and the drive motor 170 may be installed in an arrester rather than in the hollow body 190.

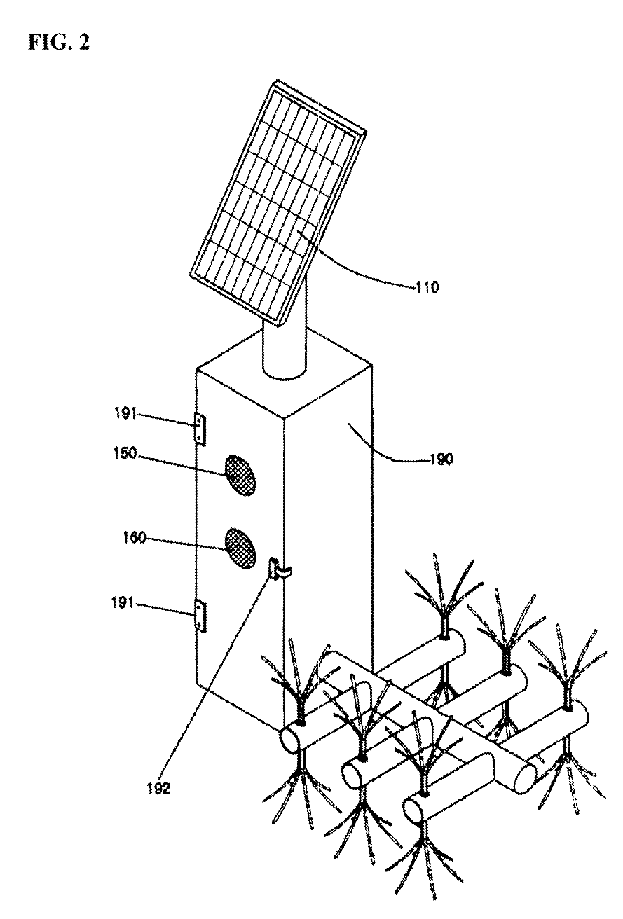

The hollow body 190 is provided with a fixing band which fixes the bird repelling device 100 to the telephone pole 1. In other words, the bird repelling device 100 can be reliably fixed to the telephone pole 1 by the fixing band. The hollow body 190 may be of any shape, e.g., a hollow cylindrical, rectangular or polygonal shape. As shown in FIG. 2, the hollow body 190 may be provided with a hinge 191 and a latch 192 so that it can open.

Furthermore, the bird sensor 140 is installed on the hollow body 190 and senses motion of birds or other poultry that approach it. The sound generating unit 150 and the sound wave generating unit 160 are also installed on the hollow body 190 and respectively generate sounds and sound waves that birds or the like hate depending on signals of the bird sensor 140.

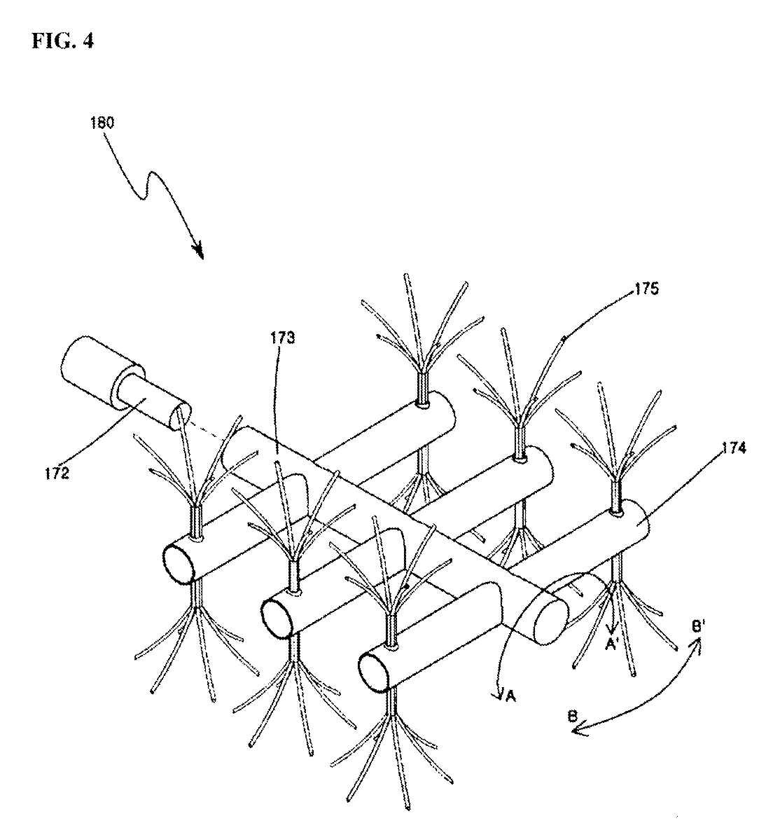

An inverter 171 is connected to the drive motor 170 to control it. A rotary rod 173 is coupled to a drive shaft 172 provided on the drive motor 170 so that the drive shaft 172 can rotate the rotary rod 173. The drive motor 170 may be configured such that it is reversibly rotated so that the rotary rod 173 can also reversibly rotate (in directions indicated by the arrow A-A′ of FIG. 4). Alternatively, the drive motor 170 may be configured such that it rotates in only one direction so that the rotary rod 173 also rotates in the one direction.

Furthermore, the drive shaft 172 of the drive motor 170 may be provided with a worm gear unit (not shown) so that the rotary rod 173 can rotate to the left and right in a circumferential direction of the telephone pole 1 (in directions indicated by the arrow B-B′ of FIG. 4). The rotary rod 173 can be disposed either above or below the cross arm 2.

A plurality of support rods 174 are arranged on the rotary rod 173 at regular intervals. Each support rod 174 is perpendicularly fixed to the rotary rod 173. In an embodiment, the support rods 174 may be disposed on opposite sides of the rotary rod 173. In place of the support rods 174, a long tassel (not shown) which can flutter in the wind may be provided on the rotary rod 173. That is, any member can be provided on the rotary rod 173 so long as it can expand an area of motion for preventing the approach of birds when the rotary rod 173 is rotated by the power of the drive motor 170. As such, a bird repelling unit that includes the support rods 174, the long tassel or other different kinds of members is provided on the rotary rod 173 so that the bird repelling unit rotates along with the rotary rod 173, thus repelling birds.

A tassel 175 is provided on an end of each support rod 174 and flutters in the wind. The tassel 175 is preferably configured such that it moves in the same manner as that of a pinwheel and has different colors so that it glitters when fluttering.

In the first embodiment of the present invention, in lieu of tassels 175, LEDs which emit light that birds or the like hate may be provided at predetermined installation positions. In this case, the LEDs receive power from the charging device 120.

The bird sensor 140 comprises an infrared sensor which can automatically detect a bird when the bird approaches within a range of 5 m. If it is required to expand an area in which the bird repelling device can repels birds, the bird sensor 140 is configured such that it has a wider detection range. The sound wave generating unit 160 can generate ultrasonic waves with a frequency between 2000 khz and 3000 khz, which is effective for repelling magpies (or other birds). In other words, the sound wave generating unit 160 is configured such that ultrasonic waves, etc. that birds such as magpies or wild animals hate are generated. The bird sensor 140 may be disposed at positions other than the inside of the hollow body 190, for example, on the solar cell panel 110.

The sound generating unit 150 can repetitively generate different kinds of sound effects that can disrupt the emotions of the birds. For instance, the sound generating unit 150 may be configured such that it generates a combination of sounds that birds such as magpies or other wild animals hate, e.g., a combination of the sounds of their natural enemies. In detail, the sound generating unit 150 may repetitively generate the sound of snakes or the like that birds hate.

Preferably, circuit components for preventing overcharge, overdischarge and overcurrent are installed in the controller 130 to give the battery a stabilized charge, so that the battery can be used over a long period of time without being replaced. Furthermore, the controller 130 preferably has an operation control function in which the mode of operation can be automatically converted between a first mode in which the device is operated for a specific period (for example, a breeding season from February to May) and a second mode in which the device is operated in a manner different from the first mode for the rest period/months, thus enhancing the durability and lifetime of the device.

The bird repelling device 100 according to the first embodiment of the present invention having the above-mentioned construction is installed above the cross arm of the telephone pole. Under normal conditions, the solar cell panel 110 collects solar heat and accumulates electrical energy in the charging device 120.

If a bird or the like approaches the device, the bird sensor 140 detects the approach of the bird. Then, the sound generating unit 150 generates the sounds that the birds or the like hate and, simultaneously, the sound wave generating unit 160 generates the ultrasonic waves that birds or the like hate, thus deterring their approach.

Furthermore, depending on the operation of the bird sensor 140, the drive motor 170 is operated so that the rotary rod 173 rotates in a normal and/or reverse direction. Then, the support rods 174 connected to the rotary rod 173 rotate, and the tassels 175 provided on the support rods 174 glitter and rotate in a manner similar to that of a pinwheel, thus confusing the bird, thereby deterring the approach of the bird. In the case where LEDs are used in lieu of the tassels 175, the LEDs emit light while the support rods 174 rotate, thus deterring the approach of the bird so that the bird cannot build a nest on the cross arm of the telephone pole.

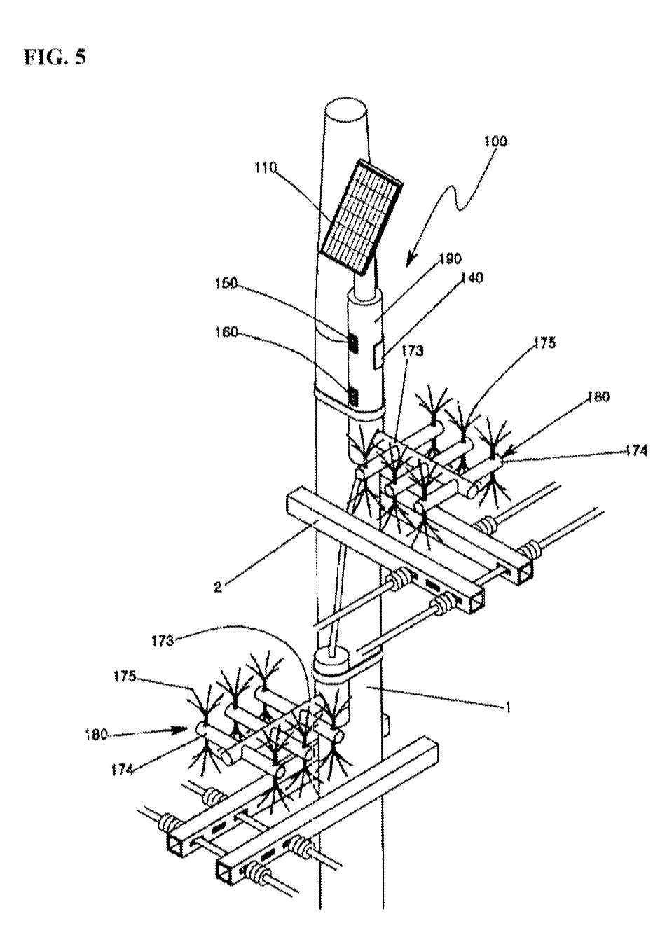

As shown in FIG. 5, the bird repelling device 100 according to the first embodiment of the present invention may be modified into a second embodiment which is configured such that regardless of the location of the cross arm 2 on the telephone pole 1 or the number of cross arms 2, the bird repelling device 100 can be provided above each cross arm 2. Operating and controlling the second embodiment can be realized by supplementing the function of the controller 130.

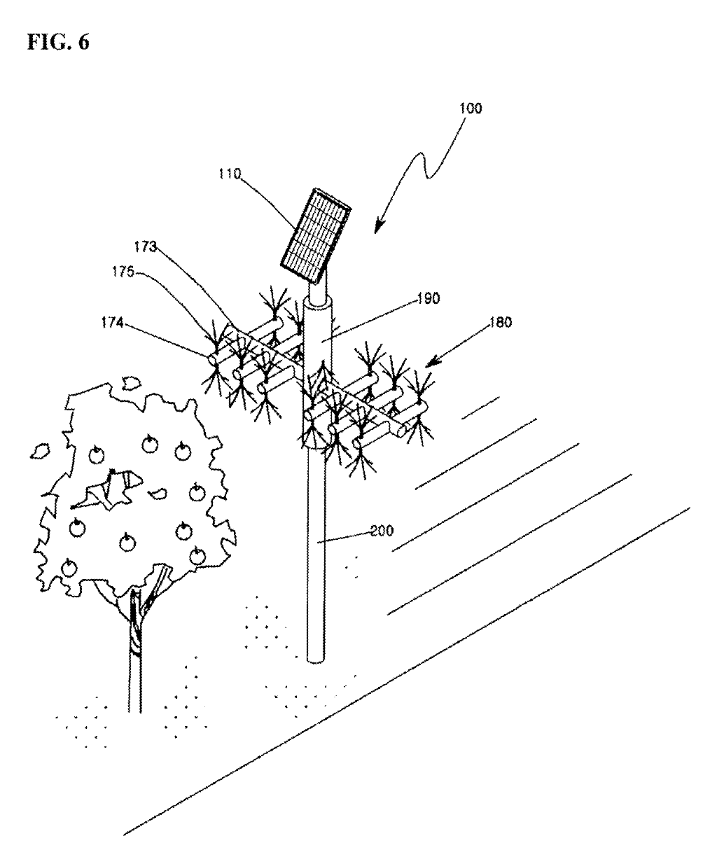

As shown in FIG. 6, the bird repelling device 100 according to the first embodiment of the present invention may be modified into a third embodiment which is configured such that the hollow body 190 is provided on a support pole 200 that is installed on a place such as an orchard or farmland (a planted field) where there is a possibility of fruit trees or crops being damaged by birds or wild animals.

The bird repelling device 100 of the present invention may be able to use general electricity as well as being able to use electrical energy obtained by a process in which the device 100 collects solar heat and converts the collected heat energy into electrical energy. In other words, the bird repelling device 100 of the present invention may use power transmitted from a typical power supply to operate the bird sensor 140 or other elements without having the solar cell panel 110, the charging device 120 and the controller 130 which must use solar heat.

The bird repelling device 100 of the present invention may further include a smoke screen generating unit (not shown). The smoke screen generating unit is based on the principle that all birds or animals flee in the event of a fire. The smoke screen generating unit discharges dense smoke and smell using chemicals, creating the same effect as that of a smoke bomb. To enhance the effect, an LED may be used to make conditions similar to that of the event of a fire, and the smoke screen generating unit may be configured such that smoke that exudes smell that birds hate is discharged.

The smoke screen generating unit is effective over a wide area such as an orchard or farmland. The smoke screen generating unit contains a chemical that has the above-stated function in a container so that upon a signal being transmitted thereto from the bird sensor 140 the chemical is discharged to the outside.

The bird repelling device 100 may further include a shooting unit (not shown). The shooting unit shoots an eagle- or snake-shaped plate that birds hate, thus chasing birds far away. The shooting unit may configured such that the plate that has been shot returns to its launch position after flying over a large area based on the principle of a boomerang and then is reloaded, but the construction thereof is complicated. Therefore, the shooting unit is preferably configured such that the plate falls onto the ground around the launched position.

More preferably, the plate of the shooting unit is made of a material which is biodegradable after having fallen onto the ground. For example, the plate is made of material that does not easily dissolve in water but can be decomposed and become fertilizer as time passes, like a starch toothpick. The shooting unit is effective for a wide area such as an orchard or farmland. The shooting unit contains a plurality of above-stated plates stacked in a container so that upon a signal being transmitted thereto from the bird sensor 140 a plate is launched.

The bird repelling device 100 of the present invention May include an air supply type repelling unit (not shown). The air supply type repelling unit is configured such that air is injected into a long tube or the like that has been dropped or rolled so that the tube is momentarily extended, thus frightening birds and repelling them. The structure of rolling the long tube can be realized by providing a winding structure inside or outside the tube. Preferably, the air supply type repelling unit includes an air storage container of a predetermined capacity and a plurality of long tubes which can be extended by air supplied from the air storage container, wherein upon a signal being transmitted from the bird sensor 140 air is supplied from the air storage container into the tubes so that the tubes are momentarily extended and then returned to their original positions.

### INDUSTRIAL APPLICABILITY

As described above, in a bird repelling device according to the present invention, when a bird sensor detects the motion of birds or the like around a telephone pole, a sound generating unit, a sound wave generating unit and a moving unit are operated to deter the birds from approaching the telephone pole or building a nest, thus preventing electrical components or wires installed on the telephone pole from being damaged or contaminated by birds, and preventing a nest made of metallic substances from causing a power failure incident.

Furthermore, the bird repelling device may be installed in a place such as an orchard or farmland (a sown field) to prevent birds or other wild animals from approaching the orchard or farmland and from damaging fruit trees or crops.

1. A bird repelling device comprising:
an electricity supply unit;
a bird sensor receiving power from the electricity supply unit, the bird sensor detecting approach of birds;
a sound generating unit and a sound wave generating unit operated by a signal transmitted from the bird sensor; and
a moving unit moved by a drive motor that is operated by a signal transmitted from the bird sensor, the moving unit comprising: a rotary rod connected to a drive shaft of the drive motor, the rotary rod being rotated by the drive shaft; and a bird repelling unit mounted to the rotary rod so that the bird rod rotates to repel the birds.

2. The bird repelling device according to claim 1, wherein the electricity supply unit comprises: a solar cell panel collecting solar heat and converting the collected heat energy into an electrical energy; a charging device accumulating the electrical energy transmitted from the solar cell panel; and a controller controlling the electrical energy accumulated in the charging device.

3. The bird repelling device according to claim 2, further including:
a hollow body coupled to a lower end of the solar cell panel, the hollow body housing the charging device, the controller and the drive motor therein.

4. The bird repelling device according to claim 1, wherein the bird repelling unit comprises a plurality of support rods installed on the rotary rod at positions spaced apart from each other at predetermined intervals, the support rods being perpendicular to the rotary rod.

5. The bird repelling device according to claim 4, wherein the support rods are disposed on opposite sides of the rotary rod.

6. The bird repelling device according to claim 5, wherein the bird repelling unit further comprises a tassel provided on an end of each of the support rods, the tassel having different colors and fluttering in a wind.

7. The bird repelling device according to claim 5, wherein the bird repelling unit further comprises an LED provided on an end of each of the support rods, the LED receiving power from the electricity supply unit and emitting lights of different colors.

8. The bird repelling device according to claim 1, further comprising:
a smoke screen generating unit operated by a signal transmitted from the bird sensor, the smoke screen generating unit using a chemical and discharging dense smoke and smell, thus producing an effect of a smoke bomb.

9. The bird repelling device according to claim 8, wherein the smoke screen generating unit comprises an LED emitting light, thus simulating conditions of fire.

10. The bird repelling device according to claim 1, further comprising:
a shooting unit operated by a signal transmitted from the bird sensor, the shooting unit shooting a plate to repel the birds.

11. The bird repelling device according to claim 10, wherein the shooting unit is configured such that the plate flies over a large area using a principle of a boomerang and then falls onto a ground around a position at which the plate has been launched.

12. The bird repelling device according to claim 1, further comprising:
an air supply type repelling unit operated by a signal transmitted from the bird sensor, the air supply type repelling unit comprising a long tube configured such that when air is injected into the long tube that has been drooped or rolled, the tube is momentarily extended, thus frightening the birds and repelling the birds.
